(19) United States
(12) Patent Application Publication
(10) Pub. No.: US 2005/0000955 A1
(43) Pub. Date: Jan. 6, 2005

(54) Automotive coffee maker

(76) Inventor: Nghia Ngo Vu, San Jose, CA (US)

Correspondence Address: NGHIA NGO VU, 5118 VERA LN, SAN JOSE, CA, 95111, US

(21) Appl. No.: 10/612,509

(22) Filed: Jul. 3, 2003

(51) Int. Cl. F27D 11/00

(52) U.S. Cl. 219/438; 392/444

(57) ABSTRACT

A 12 Volt DC electric cooker to be installed in vehicles and powered by the vehicle charging systems and batteries themselves. The unit is used to heat liquids or foods.

### BRIEF DESCRIPTION OF THE INVENTION

This is an invention for a DC electric cooker. It uses the 12 volt power of a car to heat or boil a small volume of liquid when traveling.

### SUMMARY OF THE INVENTION

The heart of the invention is an integrated circuit that energizes two DC heaters (glow plugs.) Heat transfers to the surface housing cooker at a preset temperature of 100 degree Celsius. A timer controls the time and deenergizes the heaters. A stainless steel cup is used to hold the liquid to be heated.

### DRAWINGS

FIG. 1 is a view of the automotive coffee maker.

FIG. 2 is a schematic of the integrated circuit.

### DETAILED DESCRIPTION OF THE INVENTION

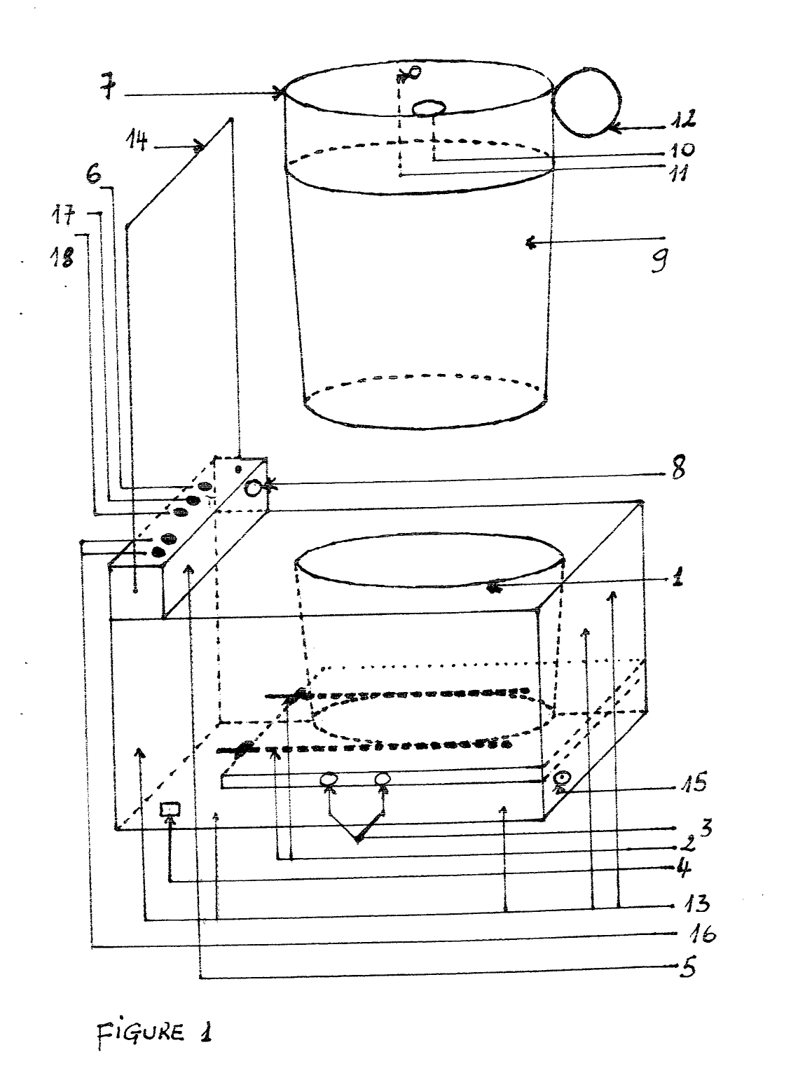

FIG. 1:
1. The surface housing cooker;
2. Two heaters (glow plugs);
3. Two temperature switches;
4. Rolling switch;
5. Integrated circuit PC board;
6. Main switch;
7. Cap of the cup;
8. Safety switch;
9. The stainless steel cup;
10. Small hole for to drink;
11. Small bole;
12. Handle;
13. Five side covers of the coffee maker;
14. Safety cap cover;
15. Female DC 12 volt plug.;
16. Two LEDs;
17. Trigger switch;.
18. Timer switch;

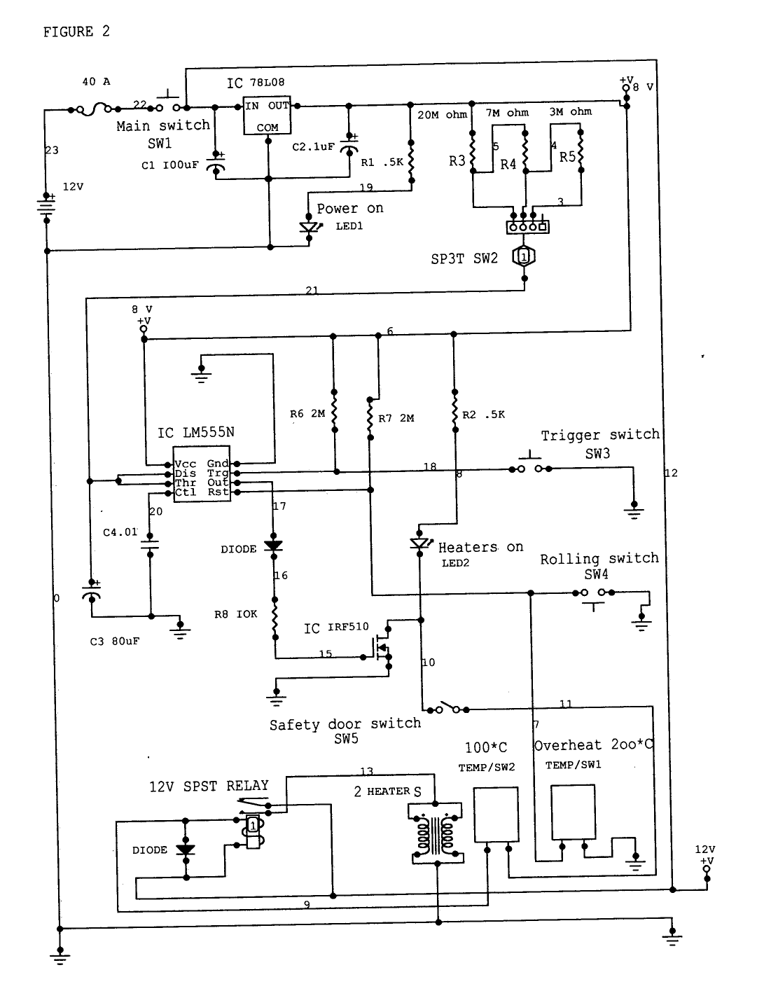

FIG. 2:
A. There are three Semiconductors: 1 Voltage regulator IC 78L08; 1 Timer IC LM555N; 1 N channel mosfet IC IRF 510;
B. Resistors: 2 Resistors. 0.5 k ohm; 1 Resistor 20M ohm; 1 Resistor 7 M ohm; 1 Resistor 3 M ohm; 2 Resistors 2 M ohm; 1 Resistor 10 k ohm;
C. LEDs: Two LEDs
D. Diodes: 2 diodes 1N914
E. Capacitors: 1 Electrolytic capacitor 100 uF; 1 Electrolytic capacitor 0.1 uF; 1 Monolithic ceramic capacitor 0.01 uF; 1 Tantalum capacitor 80 uF;
F. Switches: 1 Main switch SW1; 1 Timer SP3T SW2; 1 Trigger switch SW3; 1 Rolling switch SW4; 1 Safety switch SW5; Temperature SW2 100*C; 1 Temperature switch SW1 200*C.
G. Heaters: 2 DC heaters 12 volt. 1 Relay 12 volt SPST
H. Fuse: 1 Fuse 40 A

### Specifications

Followed by reference numbers (1) to (18) in FIG. 1 page 3.

Reference Number (1) FIG. 1:

The surface housing cooker is made of die-cast aluminum alloy. It has a square bottom and cylindrical wall, which wraps around the stainless steel cup, #(9) FIG. 1.The bottom and the wall form one unit.

The bottom is 0.65 inch thick. On the left side, it has two screw threads, which hold two heaters in place, #(2) FIG. 1.

On the front side, it has two screw threads, holding temperature switch 1 and temperature switch 2, #(3) FIG. 1.

The surface housing cooker unit is placed in a metal container with five sides around the unit cooker, #(13) FIG. 1.

Reference Number (2) FIG. 1:

The two heaters #(3) FIG. 1 are in their respective places. The commercial name of these heaters is Glow plug, invented on Nov. 30, 1927 by Bosch company of Germany. The glow plugs will reach 850 degrees Celsius or 1,562 degree F. in 8 seconds.

The outer shell of the heaters, is negative (or ground) poles, and have threads on one end. The heaters are screwed in pre-screw threads inside the bottom of the surface housing cooker.

The inner shell of the heater has screw threads at one end. The two inner shell terminals are connected in parallel to circuitry (#13) FIG. 2 and to a terminal of relay 12 volt SPST, FIG. 2. This relay switch will connect the positive end of the battery, which is circuitry (#12) FIG. 2, to circuitry (#13) FIG. 2 to supply the electrical currents to heat the two heaters. The relay is turned on by IC IRF 510, when the trigger switch, #(17) FIG. 1, is momentarily pushed down, closing the contact and bringing circuitry (#18) FIG. 2 to 0 (zero) volt. When IC LM555N Pin Out (out put) is at 8 volts, a current passes through circuitry (#17) FIG. 2, diode IN914, circuitry (#16) FIG. 2, resistor R 8 FIG. 2, and through circuitry (#15) FIG. 2, turning on IC IRF 510 FIG. 2. IC IRF 510 connects Ground to circuitry (#10) FIG. 2 and the Safety door switch FIG. 2. This turns on circuitry (#11) FIG. 2 and the 100*C Temp/SW2 FIG. 2, which, in turn, turns on circuitry (#9) FIG. 2, supplying and electrical current to the coil of the relay 12 volt SPST FIG. 2. The relay will connect circuitry (#12) to circuitry (#13) FIG. 2, to supply the current to the two heaters heating up the surface housing cooker.

The wall of housing cooker is of 0.05 inch thick and 3 inches high. The front side of the bottom of surface housing cooker has two pre-screw threads, which are used to tie the two temperature switches in their positions, #(3) FIG. 1.

Reference Number (3) FIG. 1:

These are two temperature switches in their own respective holes: Temperature switch 1, which closes at above 200° C. and temperature switch 2, which opens at above 100° C.

Temperature switch 1 is labeled “overheat 200° C. Temp/SW1” in FIG. 2. When it is at its normally open position, it keeps the surface housing cooker from heating up above 200 degree Celsius. Whenever the surface housing cooker unit temperature exceeds 200 degree Celsius, the 200° C. Temp/SW1 will close to Ground. This results in the entire heating unit being shut off.

Temperature switch 2 is labeled “100° C. Temp/sw2” in FIG. 2. When it is at its normally closed position, it keeps the surface housing cooker at 100 degree Celsius. Whenever the bottom of the surface housing unit temperature exceeds 100 degree Celsius, the Temp/sw2 in FIG. 2 will open, cutting off electricity to the heaters, and in effect shutting them off. Whenever the bottom temperature gets below 100° C., the Temp/SW2 closes again and conducts electricity to the heaters. Tem/SW2 will therefore turns itself on and off to maintain the bottom of the surface housing cooker at 100° C.

Reference Number (4) FIG. 1:

SW4 in FIG. 2 is a Rolling Switch or liquid mercury switch. It is normally in the open position. If the car is involved in an accident, the switch will close to Ground and thus shut off electricity to the heaters, turning the unit off.

Reference Number (5) FIG. 1:

The PC board is labeled #(5) in FIG. 1. It is mounted under the main control panel. It includes electronic components:
Voltage regulator IC 78L08,
Timer IC LM555N,
N channel Mosfet IC IRF 510,
Resistors: R1, R2, R3, R4, R5, R6, R7, R8,
Two LEDs. Two diodes. Capacitors: C1, C2, C3, C4,
Main switch: SW1,
Timer switch: SP3T SW2,
Trigger switch: SW3,
Relay 12 volt SPST FIG. 2.

These electronic devices will be laid out and mounted on a single board and have quick plugs terminals on PC board to connect to 100° C. Temp/SW2, Overheat200° C. Temp/SW1, the two heaters and Rolling switch SW4.

Reference Number (6) FIG. 1:

This is the main switch (SW1 in FIG. 2) used to turn the power to the PC board on and off and to manually turn off relay 12 volt SPST in FIG. 2.

Reference Number (7) FIG. 1:

The cap of the stainless steel cup is to prevent spilling liquid in cup (7) FIG. 1.

Reference Number (8) FIG. 1:

The safety door switch, #(8) FIG. 1, is mounted under the top panel. When the Safety cap cover, #(14) FIG. 1, of the unit is open, this safety door switch opens the circuitries #10 and #11 in FIG. 2 to turn the coil of the 12 volt relay off. This shuts off electricity to the two heaters.

Reference Number (9) FIG. 1:

The stainless steel cup, (9) FIG. 1, works as a cooking pot.

Reference Number (10) FIG. 1:

There is a small hole, #10 FIG. 1, on top of the cap, (7) FIG. 1, of the stainless steel cup for water to pass through.

Reference Number (11) FIG. 1:

Another small hole, #(11) FIG. 1 at the top of the cap, (7) FIG. 1, of stainless steel cup to release steam from the hot water.

Reference Number (12) FIG. 1:

Number (12) FIG. 1 is the handle, positioned at the side of the stainless steel cup (9) FIG. 1.

Reference Number (13) FIG. 1:

These are the five side covers for the unit made of thin metal with mount support to hold the cooker from in place.

Reference Number (14) FIG. 1:

This is a safety cap cover on the lop side of the whole unit to secure the stainless steel cup firmly inside the surface housing cooker.

Reference Number (15) FIG. 1:

This is a female 12 volt DC plug situated at one side of the unit. An extension wire will be used to connect this to the car battery terminals to provide power to the unit when the vehicle is in operation or when it is parked. A 40 Ampere fuse is connected in series with circuitries (#23) and (#22) in FIG. 2 to protect shorting in the unit.

Reference Number (16) FIG. 1:

These are two LEDS lights.

When the main switch SW1 is on, power is available to the PC board and one terminal of the relay 12 volt SPST FIG. 2, turning the green LED 1, #(16) FIG. 1 on.

The Red LED 2 (16) FIG. 1 turns on when the two heaters are on.

Reference Number (17) FIG. 1:

Once the main toggle switch SW1, #(16) FIG. 1 is turned on to give power to the PC board, the a trigger switch or momentary switch, SW3 (#17, FIG. 1), is used to turn on IC LM555N to allow electricity into the heaters to turn them on.

The switch being connected through circuitry (#18) FIG. 2, When the switch being momentary push down its contacts brings Pin Trg (Trigger) of IC LM555N to logic low or O volt, IC LM555N beginning to start monostable state by setting Pin Out (Out put) of IC LM555N on logic high or 8 Volt and turns on IC IRF 510, the relay 12 volt SPST, and current being supply for two heaters, IC LM555N automatically turns off IC IRF 510, the relay 12 volt SPST after the setting time is expired.

Reference Number (18) FIG. 1:

This timer switch, (18) FIG. 1, is a Singe-Pole-Three-Throw switch. There are three switching positions.

First position: Contact of the switch SP3T SW2 connect circuitry (#21) FIG. 2 through resistance R3 20 Mega ohms, the positive electrons will be fill up in Tatalum capacitor C3 FIG. 2, when the positive electrons in C3 reach ⅔ voltage of 8 volt, Pin Out (Out put) of IC LM555N goes logic low or 0 volt, time is expired. IC LM555N turns off IC IRF 510 and relay 12 volt SPST and current being disconnect from two heaters.

Second position: Contact of the switch SP3T SW2 connect circuitry (#21) FIG. 2 through resistance R3 20M ohm and R4 7M ohm (#5) FIG. 2, the positive electrons will be fill up in Tatalum capacitor C3 FIG. 2, when the positive electrons in C3 reach ⅔ voltage of 8 volt, Pin Out (out put) of IC LM555N goes logic low or 0 volt, time is expired. IC LM555N turns off IC IRF 510 and relay 12 volt AT and current being disconnected from two heaters.

Third position: Contact of the switch SP3T SW2 connect circuitry (#21) FIG. 2 through resistance R3 20M ohm and R4 7M ohm (#5) FIG. 2 and R5 3M ohm (#4) FIG. 2,the positive electrons will be fill up in Tatalum capacitor C3 FIG. 2,when the positive electrons in C3 reach ⅔ voltage of 8 volt, Pin out (out put) of IC LM555N goes logic low or O volt, time is expired. IC LM555N turns off IC IFR 510 and relay 12 volt SPST and current being disconnect from two heaters.

1. A 12 Volt DC electric cooker comprising of a PC board to control a relay to supply current to two glow plugs to generate heat for surface housing cooker.
